(19) United States
(12) Patent Application Publication
(10) Pub. No.: US 2026/0152417 A1
(43) Pub. Date: Jun. 4, 2026

(54) HYPERFILTRATION SYSTEM AND METHOD WITH PRESSURE EXCHANGE

(71) Applicant: DDP SPECIALTY ELECTRONIC MATERIALS US, LLC, Wilmington, DE (US)

(72) Inventors: Steven JONS, Edina, MN (US); Robert HUEHMER, Edina, MN (US)

(21) Appl. No.: 19/122,618

(22) PCT Filed: Nov. 16, 2023
(86) PCT No.: PCT/US2023/080141

§ 371 Date: Apr. 18, 2025

Related U.S. Application Data
(60) Provisional application No. 63/384,194, filed on Nov. 17, 2022.

(51) Int. Cl. C02F 1/44

(52) U.S. Cl. CPC C02F 1/444; C02F 2201/005; C02F 2209/40; C02F 2303/10

(57) ABSTRACT

The present invention provides a semi-batch method and a hyperfiltration system for treating a raw water. The hyperfiltration system is suitable to switch between two modes: a recirculation mode wherein the concentrate stream from hyperfiltration elements is recycled and a flush mode that sends the concentrate stream to discharge. The hyperfiltration system includes an energy recovery device suitable to recover energy from the concentrate stream during the flush mode. Liquid flows through the energy recovery device during at least a portion of said recirculation mode. Preferably the energy recovery device is an isobaric energy recovery device or a pressure exchanger.

### FIELD OF THE INVENTION

The present invention relates to a method and system for semi-batch treatment of a raw water using hyperfiltration.

### BACKGROUND OF THE INVENTION

Several patents, patent applications and publications are cited in this description in order to more fully describe the state of the art to which this invention pertains. The entire disclosure of each of these patents, patent applications and publications is incorporated by reference herein.

The combination of climate change and water scarcity has resulted in an increased need to purify alternative water supplies for beneficial use at lower energy consumption. Currently, conventional reverse osmosis is largely used to fulfill this need. Conventional reverse osmosis (RO) is a pseudo steady-state hyperfiltration membrane process wherein a pressurized feed stream is continuously divided into two streams, a permeate stream and retentate stream. Additional recovery of the feed stream is accomplished by adding additional hyperfiltration membrane elements in series. Semi-batch reverse osmosis is a novel method of desalinating water using hyperfiltration that utilizes two distinct main modes of operation. During the first mode, the retentate stream is recycled and mixed with the feed stream prior to entering a pressure vessel containing membranes. Consequently, the concentration of salts increases over the duration of the first mode operation. In the second mode, the concentrate is directed to waste, allowing for de-concentration of salts from the vessel.

Semi-batch reverse osmosis systems allow for lower energy consumption than conventional reverse osmosis systems. In U.S. Pat. No. 7,695,614 B2 , Efraty describes a semi-batch hyperfiltration system wherein energy consumption is lower than a conventional reverse osmosis system, without the use of an energy recovery device in the semi-batch processes. Efraty describes the process as being attractive for high recovery hyperfiltration (about 75%-95%) of low concentration brackish water. At lower recoveries, the advantages of the process are less attractive. To address the inefficiencies associated with the process, Efraty developed the process described in U.S. Pat. No. 7,628,921 B2 . The addition of a “side-conduit” in that process extends the advantages of the semi-batch process to much lower recoveries, allowing the process to be used for seawater desalination and similar high-osmotic strength solutions. As a further refinement, Efraty also proposed (U.S. Pat. No. 11,198,096 B1 ) systems using a pressure exchange type of energy recovery device (ERD) instead of the “side-conduit”, enabling improved efficiency, lower foot-print and reduced capital costs in some cases.

Several different high-efficiency ERD are available in the market. Pressure exchangers are devices commonly used in conventional hyperfiltration systems (systems comprising reverse osmosis or nanofiltration membranes) to transfer energy from a high-pressure concentrate stream to a low-pressure feed stream. U.S. Pat. No. 2,675,173 describes an early pressure exchanger using a cylindrical rotor to impart pressure exchange between a high-pressure stream and a low-pressure stream. Similarly, U.S. Pat. No. 4,887,942A and EP 1,508,361 B1 also describe a motor driven pressure exchanger with similar flow paths. U.S. Pat. No. 7,306,437 B2 describes a system where tangential flow into a low-pressure inlet port provides a velocity vector that imparts rotational momentum to the rotor. Other rotary isobaric devices impart rotational momentum to the rotor from the high-pressure ports. Piston based ERDs, such as the Dual Work Energy Exchanger (DWEER), rotary vane ERDs (U.S. Pat. No. 9,708,924), and other isobaric ERDs also offer similar advantages.

It is nonetheless desirable to provide an improved system suitable for treating water with potential for higher water recovery, lower energy usage, and with increased reliability.

### SUMMARY OF THE INVENTION

A process for treating a raw water comprising:
providing a semi-batch hyperfiltration system 2 comprising:
   a raw water source 4;
   a feed line assembly 6 comprising a first feed path 10 extending from said raw water source 4 to a high-pressure pump 14, a second feed path 12, and a first junction 8 located within said first feed path 10 that connects said first feed path 10 to said second feed path 12;
   a pressure vessel assembly 22 comprising a feed inlet 24, a concentrate outlet 26, a permeate outlet 28, and at least one pressure vessel 23 containing a plurality of hyperfiltration elements 54;
   a recirculation loop 20 comprising a second junction 18 connected to said high-pressure pump 14, said recirculation loop 20 further comprising a feed flow path through the pressure vessel assembly 22 from the feed inlet 24 to the concentrate outlet 26, and a return path 32 external to the pressure vessel assembly 22 suitable to enable flow from the concentrate outlet 26 to the feed inlet 24; wherein a first section 32′ of the return path 32 joins the concentrate outlet 26 to a third junction 34 and a second section 32″ of the return path 32 joins a fourth junction 38 to the feed inlet 24; wherein the second section 32″ contains the second junction 18 and a recirculation pump 40; and
   an energy recovery device (ERD) 42 comprising four ports:
      a first ERD inlet port 44 fluidly connected to the second feed flow path 12,
      a first ERD outlet port 46 suitable to provide a pressurized raw water to the recirculation loop 20 through the fourth junction 38,
      a second ERD inlet port 48 suitable for receiving a pressurized concentrate stream from the recirculation loop 20 through the third junction 34,
      a second ERD outlet port 50 fluidly connected to a brine effluent line 52 and suitable to provide a depressurized concentrate stream to said brine effluent line 52; and
repeatedly switching between first and second modes of operation, wherein
   said first mode of operation is characterized by enabling flow between said first section 32′ of the return path 32 and said second section 32″ of the return path 32, and allowing concentrate fluid from the concentrate outlet 26 to mix at the second junction 18 with flow from the high-pressure pump 14, such that a combined stream is conveyed to the pressure vessel inlet 24; and liquid flows through the ERD 42 during at least a portion of said first mode; and
   said second mode of operation is characterized by preventing flow between said first section 32′ of the return path 32 and said second section 32″ of the return path 32; passing a portion of fluid from the raw water source 4 sequentially into the second feed path 12, the first ERD inlet port 44, the first ERD outlet port 46, the fourth junction 38, and the second section 32″ of the return path 32; and passing concentrate fluid from the concentrate outlet 26 sequentially into said first section 32′ of the return path 32, the third junction 34, the second ERD inlet port 48, the second ERD outlet port 50, the brine effluent line 52, and a brine discharge 68.

The advantages and features of novelty that characterize the invention are pointed out with particularity in the claims annexed hereto and forming a part hereof. For a better understanding of the invention, its advantages, and the objects obtained by its use, however, reference should be made to the drawings which form a further part hereof, and to the accompanying descriptive matter, in which there is illustrated and described one or more preferred embodiments of the invention.

### BRIEF DESCRIPTION OF THE DRAWINGS

FIGS. 1a and 1b illustrate configurations for two operating modes, recirculation and flush, respectively, of a prior-art semi-batch system that includes energy recovery.

FIG. 2 illustrates a pressure vessel assembly comprising multiple parallel vessels.

FIGS. 3a-c illustrate one embodiment of the inventive system, with valves configured to allow different flow paths for different operating steps. In FIGS. 3a and 3b, a recirculation mode is enabled, where concentrate fluid is recycled to the feed inlet of the pressure vessel assembly. In FIG. 3b, a flow of liquid is simultaneously enabled through the ERD. In FIG. 3c, a flush mode is enabled, where concentrate fluid is passed through the energy exchange unit and sent to a brine discharge.

FIGS. 4a-c illustrate an alternative embodiment of the inventive system, showing steps corresponding to those in FIGS. 3a-c, but wherein a liquid flow (raw water) within the ERD in FIG. 4b is enabled by internal bypass.

FIGS. 5a-c illustrates another embodiment of the invention that demonstrates three-way valves and recycling of the flow enabled in FIG. 5b to a feed tank.

FIGS. 6a-c illustrate an alternative embodiment of the inventive system, showing steps corresponding to those in FIGS. 3a-c, but wherein a flow of liquid (concentrate) within the energy exchange device (FIG. 6b) is enabled by internal bypass.

### DETAILED DESCRIPTION OF THE INVENTION

Provided herein are a system and method for operating a semi-batch hyperfiltration system. The system described herein reduces energy consumption and enables additional water recovery as compared to other configurations that combine batch-wise reverse osmosis with energy recovery, such as the systems described in U.S. Pat. No. 11,198,096 B1, for example.

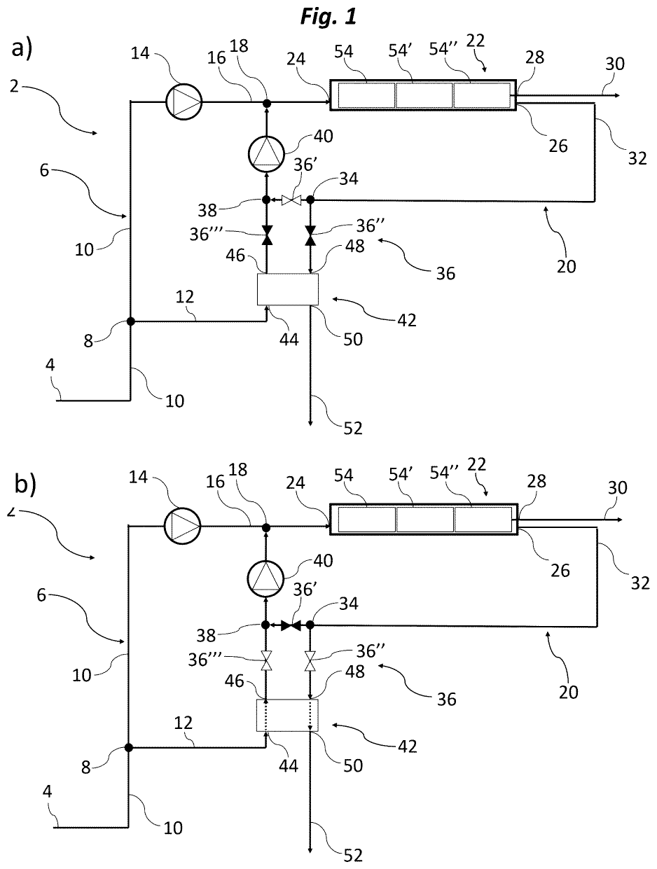

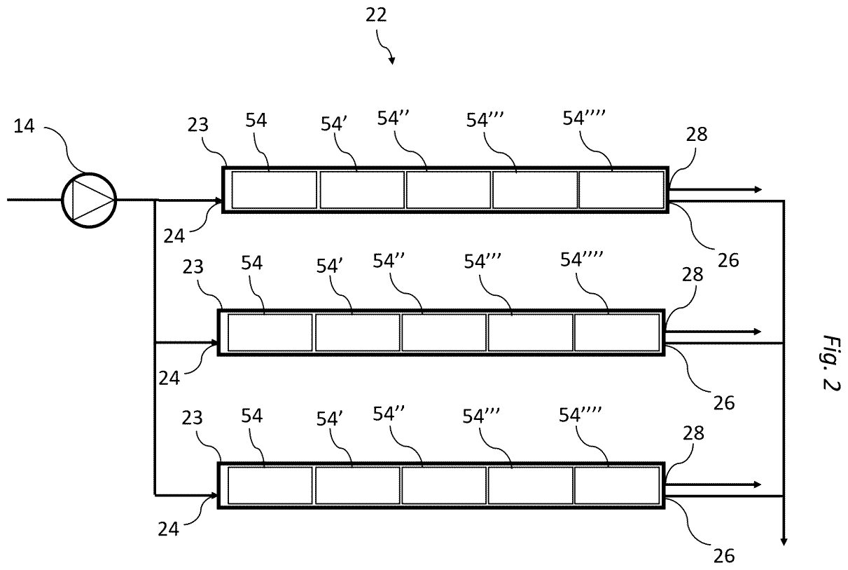

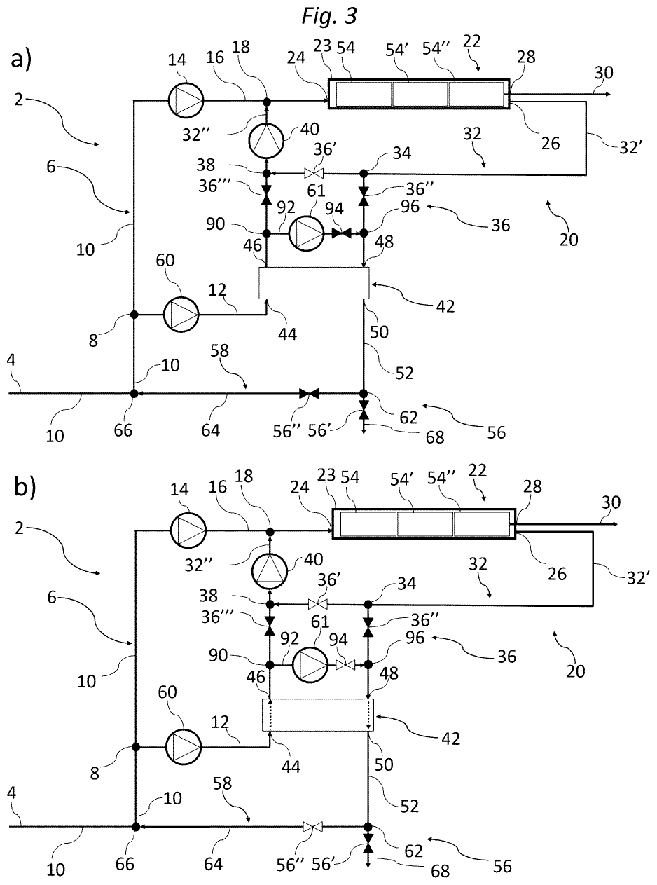

Referring now to the drawings, wherein like reference numerals designate corresponding structure throughout the views, and referring in particular to FIG. 1a, a configuration corresponding to a prior art semi-batch system that operates part of the time in a recirculation (closed circuit) mode is illustrated, wherein the concentrate from hyperfiltration elements is mixed with raw water and recirculated to the hyperfiltration elements. The system also operates part of the time in a flush mode (FIG. 1b), where concentrate from hyperfiltration elements is directed to a brine discharge. FIG. 2 illustrates a pressure vessel assembly 22. Several embodiments of the inventive system are illustrated in FIGS. 3-6, which will be subsequently described in greater detail.

The inventive semi-batch hyperfiltration system 2 includes a raw water source 4 containing a raw water to be treated. The source may be a pressurized source or a reservoir (e.g. tank or lake). A feed line assembly 6 comprises a first feed path 10 extending from said raw water source 4 to a high-pressure pump 14. The feed line assembly 6 also comprises a second feed path 12 that connects with an ERD 42. The feed line assembly 6 includes a first junction 8 located within said first feed path 10 that connects said first feed path 10 to said second feed path 12.

The system 2 includes a pressure vessel assembly 22. The pressure vessel assembly 22 comprises a feed inlet 24, a concentrate outlet 26, a permeate outlet 28, and at least one pressure vessel 23 containing a plurality of hyperfiltration elements 54. In some embodiments (not shown), the pressure vessel assembly 22 can include more than one permeate outlet 28, such as when permeate of different quality is removed from more than one end of a vessel 23 (see, e.g., U.S. Pat. No. 4,046,685). While the pressure vessel assembly 22 must include at least one pressure vessel 23, it preferably includes multiple pressure vessels 23 arranged in series and/or in parallel. FIG. 2 illustrates a pressure vessel assembly 22 with a one-dimensional array of vessels 23, but two-dimensional arrays of parallel pressure vessels 23 are also common. The feed inlet 24 provides fluid-to-be-treated to the plurality of vessels 23. Similarly, the pressure vessel assembly 22 is configured such that the permeate outlet 28 and concentrate outlet 26 receive permeate fluid and concentrated fluid, respectively, from the plurality of vessels 23.

Pressure vessels 23 contain a plurality of hyperfiltration elements 54 in series, preferably between two and eight hyperfiltration elements 54 in series. A hyperfiltration element (“membrane element”) is a cartridge containing reverse osmosis (RO) or nanofiltration (NF) membranes. Most commonly, these take the form of a spiral wound element, wherein membrane sheets, feed spacer, and permeate spacer are each wound around a central permeate tube, see, e.g., U.S. Pat. No. 10,717,050. The feed spacer regions within individual hyperfiltration elements 54 enable feed flow from one end of the vessel to another, connecting the system's feed inlet 24 and concentrate outlet 26. Similarly, within each vessel, permeate tubes of multiple hyperfiltration elements 54 are joined and are fluidly connected to the permeate outlet 28.

Still referring to FIGS. 3a-c, the system 2 comprises a recirculation loop 20 enabling concentrated fluid from the concentrate outlet 26 to be recirculated to the feed inlet 24. Specifically, the recirculation loop 20 comprises a feed flow path through the pressure vessel assembly 22 from the feed inlet 24 to the concentrate outlet 26. This feed flow path through the pressure vessel assembly 22 can include simultaneous passage through multiple different vessels 23. The recirculation loop 20 further comprises a return path 32 external to the pressure vessel assembly 22 suitable to enable flow from the concentrate outlet 26 to the feed inlet 24. A first section 32′ of the return path 32 joins the concentrate outlet to a third junction 34, and a second section 32″ of the return path 32 joins a fourth junction 38 to the feed inlet 24. The second section 32″ contains a recirculation pump 40 and a second junction 18. To provide new raw water to the recirculation loop 20, the second junction 18 within the recirculation loop 20 is connected to the downstream side of the high-pressure pump 14.

The semi-batch system of this invention includes an energy recovery device (ERD) 42 for recovering energy from the pressurized concentrate stream during a flush mode. A variety of energy recovery units such as pressure-exchange units, rotary vane units and isobaric units are known (see, e.g., EP 1,508,361 and U.S. Pat. Nos. 4,887,942; 5,338,158; 7,306,437; 7,799,221; 9,708,924; and 10,138,907). Several of these energy exchange technologies can be described as positive displacement energy exchangers, including piston based ERDs (such as the Clark Pump, Dual Work Energy Exchanger (DWEER), or axial piston devices) or progressive cavity ERDs (such as the rotary vane units). The ERD 42 includes four ports: two inlet ports and two outlet ports. The first ERD inlet port 44 is fluidly connected to the second feed flow path 12 for receiving raw water. The second ERD inlet port 48 may be connected the third junction 34, and it is intended to receive a pressurized concentrate stream from the recirculation loop 20 during the flush mode. The first ERD outlet port 46 may be connected to the fourth junction 38, and it is suitable to provide a pressurized raw water to the recirculation loop 20 during the flush mode. The second ERD outlet port 50 is fluidly connected to a brine effluent line 52, and it provides a depressurized concentrate stream to the effluent line 52. During the flush mode, the majority of fluid entering the first ERD inlet port 44 flows to the first ERD outlet port 46 and the majority of fluid entering the second ERD inlet port 48 flows to the second ERD outlet port 50, while energy (as pressure) is transferred within the ERD from the second ERD inlet port 48 to the first ERD outlet port 46.

The system 2 may be repeatedly switched between the first mode or recirculation mode and the second mode or flush mode of operation. The term “repeatedly,” as used herein, refers to an action that takes place more than once in a defined period of time, preferably more than once in a period of three hours, more preferably once in a period of one hour. The precise duration of the period of the repetition is determined by the length of time that the system 2 operates in recirculation mode. A person of skill in the art is capable of determining the time of operation in recirculation mode by modelling the pressure vessel assembly 22, for example to predict a target change in the concentrations within the hyperfiltration system. Alternatively, the system outputs such as the target conductivity of the brine may be monitored.

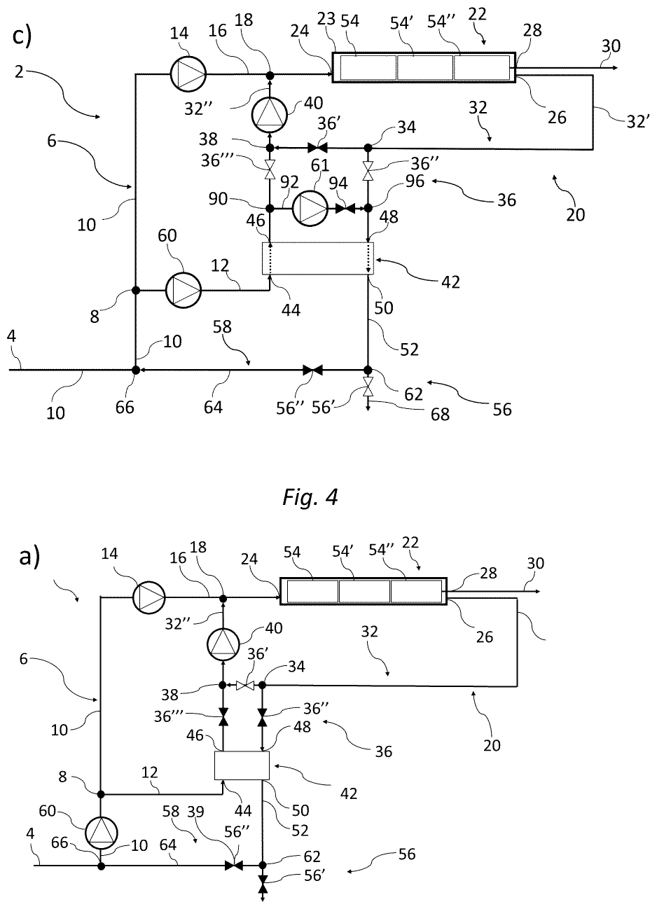

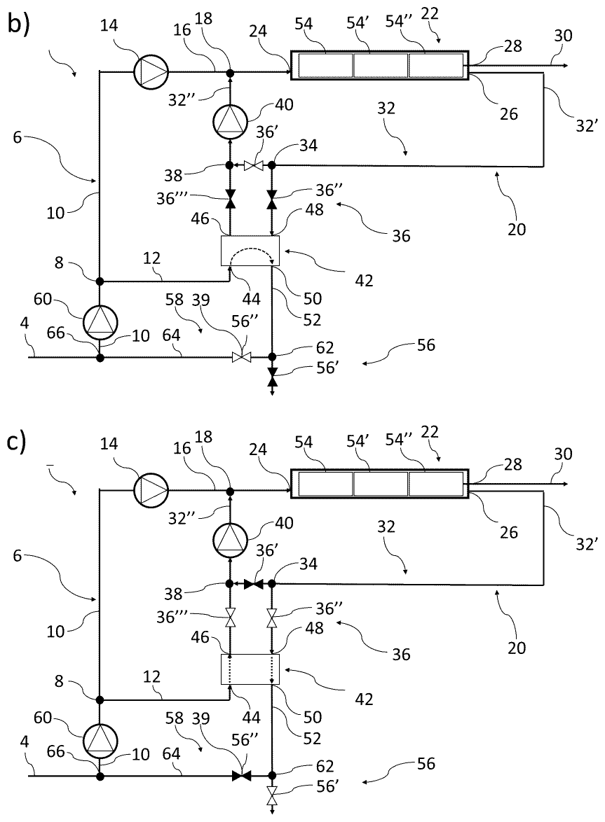

Referring now to FIG. 4b, in some ERDs such as pressure recovery (PE) units 42 an internal bypass allows some fluid to flow between the first ERD inlet port 44 and the second ERD outlet port 50, such that this may become the majority of flow in the ERD when flow is prevented through the first ERD outlet port 46 and/or the second ERD inlet port 48. The internal bypass is depicted in FIG. 4b as a curved broken arrow connecting the second feed flow path 12 and the brine effluent line 52 through ports 44 and 50. A commercial ERD comprising a pressure exchanger available from Energy Recovery is similar to the device described in Hague (U.S. Pat. No. 7,306,437). Hague describes a system where flow from the low-pressure inlet port has an inlet tangential velocity vector that imparts rotational momentum to the rotor, rather than using a motor. As a consequence of the design, when the high-pressure ports are blocked by valves or other means, and a flow is introduced through the low-pressure inlet port, rotation of the rotor is induced, with discharge into the low-pressure outlet port.

For each of the embodiments in FIGS. 3-6, a first valve collection 36 is configurable to provide distinct flow paths that enable multiple modes of operation. The multiple modes of operation include at least a recirculation step and a flushing step:
1) FIGS. 3 a-b, 4a-b, 5a-b, and 6a-b all illustrate part of a recirculation step, where flow is enabled between the first section 32′ of the return path 32 and the second section 32″ of the return path 32. In this step, concentrate fluid from the concentrate outlet 26 is mixed at the second junction 18 with raw water flow from the high-pressure pump 14, and a combined stream is conveyed to the pressure vessel inlet 24. In preferred embodiments, the system 2 operates at least 50%, more preferably 70%, more preferably 90% of the time in this recirculation step. During this recirculation step, a permeate fluid having lower concentration than the feed is removed from the system 2 via exit path 30, and this causes the concentration of fluid within the recirculation loop 20 to increase over time. During at least a part of the recirculation step, liquid flows through the ERD 42, as depicted in valve configurations of FIGS. 3b, 4b, 5b and 6b. In some embodiments, as shown in FIGS. 3b, 4b, and 5b, the recirculation step may further include operating a low-pressure pump 60 to provide a flow of raw water through at least a part of the brine effluent line 52.
2) FIGS. 3c, 4c, 5c, and 6c, illustrate a flushing step, wherein flow is prevented between the first section 32′ of the return path 32 and the second section 32″ of the return path 32. In the flushing step, fresh raw water is provided to the recirculation loop 20 and the concentrated fluid within the recirculation loop 20 is removed from the system 2. To provide a flush while recovering energy (pressure) initially present in the recirculation loop 20, two fluid streams pass through the ERD 42. A portion of fluid from the raw water source 4 is passed sequentially into the second feed path 12, the first ERD inlet port 44, the first ERD outlet port 46, the fourth junction 38, and the second section 32″ of the return path 32. At the same time, concentrate fluid from the concentrate outlet 26 is passed sequentially into said first section 32′ of the return path 32, the third junction 34, the second ERD inlet port 48, the second ERD outlet 50, the brine effluent line 52, and a brine discharge 68. Preferably, the system operates at less than 50% of the time in the flushing step.

During two parts of a recirculation step depicted in FIGS. 3a and 3b, the first valve collection 36 prevents the flow of concentrate fluid from the concentrate outlet 26 into the ERD unit 42. However, in preferred embodiments of the recirculation step, a portion of fluid from the raw water source 4 is made to pass through the ERD 42, as illustrated in FIG. 3b. Moreover, it is also preferred that this portion can be recovered. In the systems of FIGS. 3-5, a recovery path 64 enables flow from a fifth junction 62 located in the brine effluent line 52 to be directed to either a) the raw water source 4 or b) a sixth junction 66 located in the first feed path 10.

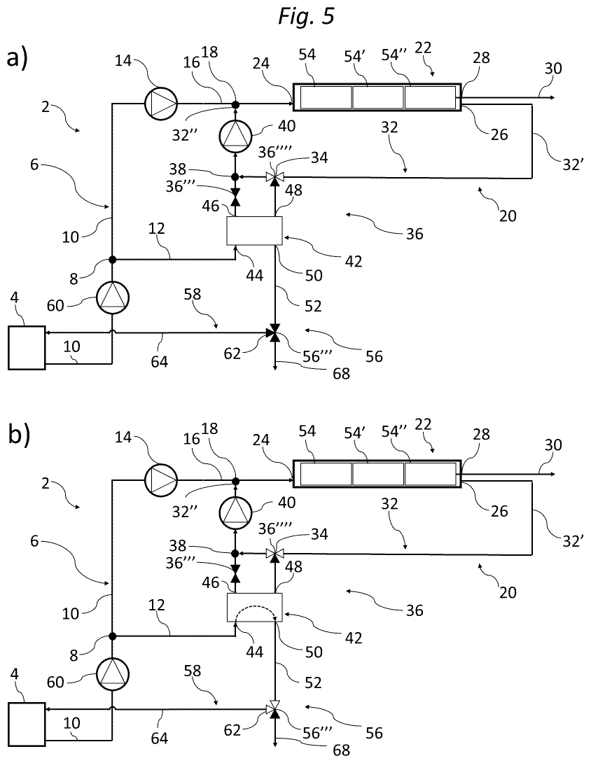

Referring to FIGS. 3, 4, and 5, a second set of valves (second valve collection 56), is suitable to direct flow from the brine effluent line 52 to either the brine discharge 68 or the recovery path 64. In its simplest embodiment, the second valve collection 56 may consist of a single three-way valve located at the junction 62 (FIG. 5). Alternatively, the second valve collection 56 may comprise two-way valves (56′, 56″) located within both the recovery path 64 and the brine effluent line 52 (See FIGS. 3 and 4).

Together, the first and second valve collections (36, 56) of FIGS. 3, 4 and 5 are preferably suitable to simultaneously prevent concentrate fluid from the concentrate outlet 26 from entering the ERD 42 and enable circulation of liquid (raw water) through the ERD unit 42. A recovery circuit 58 for circulation of raw water comprises or consists of a first portion from the second ERD outlet port 50 to the first ERD inlet port 44, which includes the recovery path 64, and a second portion that extends into the ERD 42 and allows raw water to pass from the first energy recovery unit inlet port 44 to the second energy recovery unit outlet port 50, optionally via bypass line 92 and valve 94. The recovery circuit 58 comprises the second feed path 12, the first ERD inlet port 44, the second ERD outlet port 50, a portion of the brine effluent line 52, the recovery path 64, and a portion of first feed path 10. In these embodiments, at least one low-pressure pump 60 is located within the recovery circuit 58, preferably downstream of the fifth junction 66 and upstream of the first ERD inlet port 44. The second valve collection 56 comprises at least one isolating valve 56″ that is located within the recovery circuit 58.

In preferred embodiments, such as those depicted in FIGS. 3b and 4b, a low-pressure pump 60 is in fluid communication with at least one of the ports (44, 46, 48, 50) of the ERD 42, and the low-pressure pump 60 generates a flow of raw water sequentially into the second feed path 12, through the first ERD port 44, the second ERD outlet port 50, and the brine effluent line 52. The low-pressure pump 60 enables flow within the recovery circuit 58.

For the system shown in FIGS. 3a-c, a flow path external to the ERD 42 may be used to enable fluid flow from the first ERD inlet port 44 to the second ERD outlet port 50. In

the shown embodiment, a bypass line 92 with a bypass valve 94 is suitable to provide a conduit for flow between bypass junction points (90, 96), connecting the first ERD outlet port 46 to the second ERD inlet port 48. When the bypass valve 94 is opened, the low-pressure pump 60 can induce mechanical movement within the ERD 42, and raw water may flow from the first ERD inlet port 44 to the second ERD outlet port 50, passing along a path that sequentially includes the first ERD outlet port 46, bypass junction point 90, bypass line 92, bypass junction point 96, and the second ERD inlet port 48.

FIG. 3a illustrates valve positions for a configuration when the system is in the first mode of operation, where concentrate is recycled to the feed of the pressure vessels 23. Valve 36′ is open, while the remainder of valves in the first valve collection (36″, 36′″) are closed. (Valves 56′ and 56″ are also shown as closed.)

As illustrated in FIG. 3b, prior to switching to the second mode of operation, the system may be configured in manner that allows fluid (raw water) to flow through the ERD, in this case a rotary pressure exchange (PE) unit 42. This practice can lubricate the PE unit internal components and to initiate spinning of the internal rotor (see U.S. Pat. No. 7,306,437). FIG. 3b illustrates valve positions in the second valve collection 56 that enable flow into the ERD and recovery of raw water discharged from the second ERD outlet port 50. Valve 56″ is opened and 56′ is closed, enabling at least a portion of raw water flow from junction 8 to pass through the ERD 42 and return to junction 8. The recovery circuit 58 shown comprises the second feed path 12, the first ERD inlet port 44, the second outlet port 50, a portion of the brine effluent line 52, the recovery path 64, and a portion of first feed path 10. (The recovery circuit 58 may be designed to avoid the first feed path 10.) In these embodiments, the low-pressure pump 60 is located within the recovery circuit 58, preferably downstream of the fifth junction 66 and upstream of the first ERD inlet port 44. Within the recovery circuit 58, the embodiment shown in FIG. 3b also includes a portion external to the ERD 42 that includes bypass line 92.

In FIG. 3b, a pump and valve within the bypass line 92 allow controlled flow of fluid through the ERD. A closed valve 56′ prevents flow between the second ERD outlet port 50 and the brine discharge 68 during at least the majority of time during which liquid flows through the pressure exchange device 42 in the recirculation step. Preferably, the total flow of liquid through the PE during the first mode exceeds by at least a factor of two the flow of liquid into the brine discharge 68 during the same time period.

FIG. 3c illustrates a flush or purge step, and the system preferably enters this second operation mode once the ERD 42 rotor is spinning. The figure shows valves 56″ and 36′ are closed, while valves 36″, 36′″ and 56′ are opened. In the second mode of operation, energy is exchanged from the high-pressure concentrate entering the second ERD inlet port 48 to fluid exiting the ERD 42 at the first ERD outlet port 46. At the same time, lower pressure fluid passing through the brine effluent line 52 is sent to discharge 68. This allows flow of high-pressure feed into the recirculation loop, replacing flow from the concentrate outlet 26 sent to brine discharge 68.

The first set of valves (first valve collection 36) enables switching between the recirculation and flushing modes of operation. This valve collection 36 is suitable to control flow between the second ERD inlet port 48 and the first section 32′ of the return path 32; the first section 32′ of the return path 32 and the second section 32″ of the return path 32; and the first ERD outlet port 46 and the second section 32″ of the return path 32. In FIGS. 3 and 4, the collection of valves 36 for these respective purposes are identified as 36″, 36′, and 36′″. In some embodiments, valve 36′″ can be a non-return valve (check valve).

FIGS. 4a-c illustrate another embodiment of the inventive system 2, wherein the system has a flow path internal to the ERD 42 that can enable fluid flow from the first ERD inlet port 44 to the second ERD outlet port 50. As conveyed by the dashed line in the illustration, flow through the pressure exchange unit 42, from the first ERD inlet port 44 to second ERD outlet port 50, is created by internal bypass. The first valve collection 36 in FIG. 4a is configured to allow for recirculation of feed water through the pressure vessel assembly 22. In FIG. 4b, the first and second valve collections (36, 56) still allow this recirculation of concentrate fluid from the concentrate outlet 26 to the feed inlet 24 of the pressure vessel assembly 22. However, configurations of the first and second valve collections (36, 56) also support liquid (raw water) flowing through the ERD 42, from the

first ERD inlet port 44 to second ERD outlet port 50, suitable to initiate rotational movement within the ERD 42. Similar to FIG. 3b, the arrangement in FIG. 4b also illustrates a preferred embodiment where raw water passing through the ERD 42 is recovered. (The configuration allows at least a portion of raw water from junction 8 to pass through the ERD 42 and return to junction 8 via the recovery circuit 58.) Finally, FIG. 4c illustrates a flush step.

The process illustrated in FIG. 4a illustrates one part of the recirculation step. In this process, flow through the first ERD inlet port 44 and flow through the second ERD outlet port 50 are both prevented. As compared to FIG. 4b, the closed valve 56″ in FIG. 4a prevents flow through the ERD inlet port 44. Flow through the ERD inlet port 44 is prevented because the other three ERD ports are connected to only closed paths.

Processes illustrated in FIGS. 4b and 5b are also part of the recirculation step, and liquid flows through only two of the four ports of the ERD. One may also allow small flows through the nominally closed valves, but it is intended that liquid flow predominantly through only two of the four ports of the ERD. In both cases, a valve (56′ or 56′″) is present that is suitable to prevent flow between the second ERD outlet port 50 and the brine discharge 68, and this flow to the brine discharge 68 is prevented during at least the majority of time within the recirculation step that liquid flows through the pressure exchange device 42. Preferably, the total flow of liquid through the ERD during the first mode exceeds by at least a factor of two the flow of liquid into the brine discharge 68 during the same time period.

During the recirculation step, when passing liquid through the ERD, it is preferred that there is no loss of fluid from the brine discharge 68. In FIGS. 3, 4, and 5, a brine effluent valve (56′ or 56″′) that is located in the brine effluent line 52, between the second ERD outlet port 50 and brine discharge 68 prevents this loss.

As shown in FIG. 5, a three-way valve 36″″ or 56′″ within the first or second valve collections (36, 56) may replace the function of two (two-way) valves. In FIGS. 3a-c and 4a-c, flow from the first section 32′ of the return path 32 may be directed to either the second section 32″ of the return path 32 or to the second ERD inlet port 48. Similarly, a three-way valve 36″″ within the valve collection 36 in FIG. 5 also enables a similar selection. FIG. 5 also illustrates a three-way valve 56″′ replacing two (two-way) valves (56′, 56″) depicted in FIGS. 3 and 4. Finally, FIG. 5. illustrates potential for a return of raw water from the ERD 42 to a reservoir/tank.

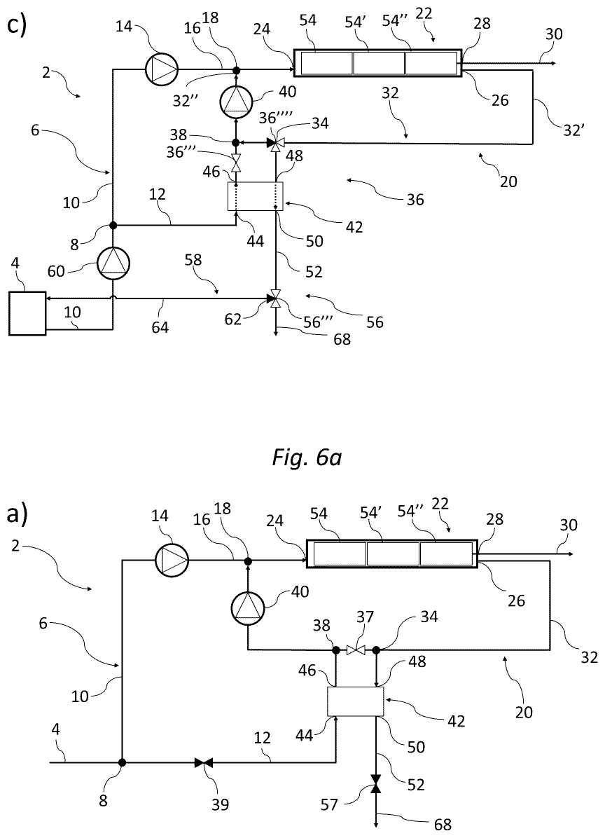

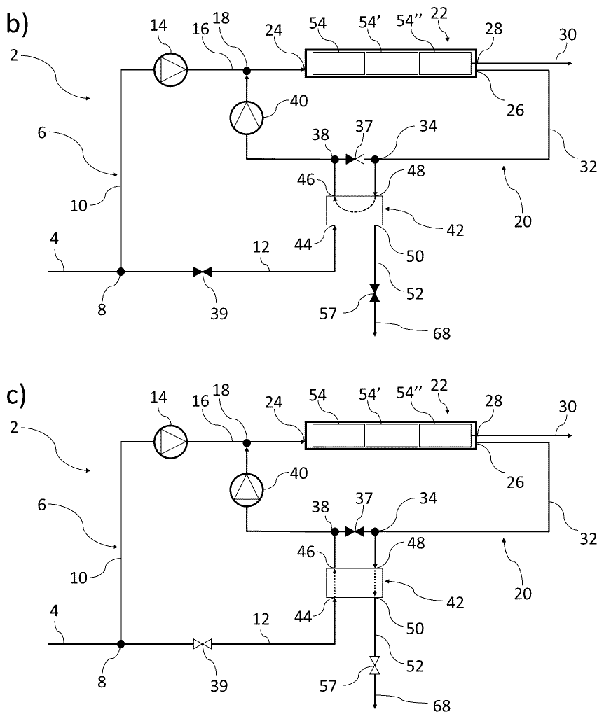

Referring now to FIGS. 6a and 6b, a first mode of operation is shown. This configuration comprises one or more pressure exchanger style of energy recovery devices, where flow from the high pressure concentrate inlet can induce rotation of the rotor. As illustrated in FIG. 6a, a significant portion of flow, potentially all flow, bypasses the ERD 42 through control valve 37 located in a section of the return path 32 connecting the third junction 34 and the fourth junction 38. The control valve 37 may be adjusted during the first mode to modify the rate at which liquid flows through the ERD 42. An open or largely-open control valve may be practiced may be practiced for the majority of time (a first time interval) in the first mode of operation. As illustrated in FIG. 6b, reducing flow through the control valve 37 causes increased bypass flow through the ERD 42, from the second ERD inlet port 48 to the first ERD outlet port 46. This may be practiced during a portion (a second time interval) of the first mode of operation. In a preferred embodiment, rotational momentum can be imparted to a rotor within the ERD 42 prior to beginning the second mode of operation. In another preferred embodiment, the rotor spins throughout the first mode. In still another preferred embodiment, the rotor spins at a faster rate in the second time interval compared to the first time interval of the first mode. Flow through first ERD inlet port 44 and second ERD outlet port 50 can be prevented during at least a portion of the first mode, if not all of the first mode, by maintaining valve 39 and valve 57 in the closed position. Preferably, liquid flows predominantly through only the other two ports (48, 46) of the ERD during the first mode. Preferably, the first mode is divided into a first time interval and a second time interval, wherein the second time interval is of shorter duration than the first time interval, but wherein a greater volume of liquid flows through the ERD 42 during the second time interval. The portion of time that the internal bypass in the ERD 42 is engaged is desirably a small duration of the first mode of operation, preferably less than 50% of the duration of the first mode of operation, more preferably less than 25% of the first mode of operation, more preferably less than 10% of the first mode of operation.

Both FIGS. 6a and 6b show the effluent valve 57 closed. Flow between the second ERD outlet port 50 and the brine discharge 68 is preferably prevented during at least the

majority of time in the first mode that liquid flows through the ERD 42. Preferably, the flow of liquid through the ERD 42 during the first mode exceeds by at least a factor of two the flow of liquid into the brine discharge 68 during the same time period.

Referring to FIG. 6c, during the second mode of operation, control valve 37 is closed to direct all of the flow in the loop 32 into the second ERD inlet port 48 and out the second ERD outlet port 50. Valve 39 is opened to establish a fluid pathway for raw water to the ERD inlet port 44. Effluent valve 57 is opened to enable concentrate flow to pass between the second ERD outlet port 50 and the brine discharge 68. A first stream of fluid entering the first ERD inlet port 44 flows to the first ERD outlet port 46. A second stream of fluid entering the second ERD inlet port 48 flows to the second ERD outlet port 50. The ERD 42 transfers pressure from the second fluid stream to the first fluid stream. The duration of the second mode of operation is typically less than 100%, more preferably less than 75%, more preferably less than 50%, more preferably less than 25% of the duration of the first mode of operation.

To return to the first mode of operation, control valve 37 is opened, and valves 39 and 57 are closed to re-establish the recirculation loop.

All embodiments of system 2 include a control unit. Those of skill in the art are capable of selecting a suitable control unit. Non-limiting examples of suitable types of control units include computer systems, solid state electronic systems such as programmable logic controllers (PLC), and electromechanical systems. The control unit is suitable to position individual valves (e.g. 37, 39, 57, 94) and valve collections (36, 56), enabling switching between the different modes of operation. Preferably, the control unit also receives measurements such as flow, temperature, conductivity, turbidity, and pressure from sensors at various locations within the system 2. While the control unit may switch between operating modes based solely on specific time intervals, preferably the control unit uses measurements from sensors to determine when to switch between the different modes of operation. The control unit preferably also engages the low-pressure pump 60 and can preferably create a flow of liquid through the ERD 42 during at least a portion of the recirculation step. In some embodiments, liquid is caused to flow through the ERD 42 during a portion of the recirculation step immediately prior to switching into the flushing step. In other embodiments, liquid is caused to flow through the recovery circuit 58 during at least the majority of the recirculation step.

The invention includes a process for operating the described system, including the various optional embodiments mentioned and their combinations. The process includes repetitively switching between the recirculation step and the flushing step. In some embodiments, the recirculation step may further comprise a first time interval where liquid is prevented from flowing through the pressure-exchange unit 42 and a second time interval where liquid is caused to flow through the pressure exchange unit 42 prior switching into the flushing step.

In some embodiments, the ERD associated with a semi-batch hyperfiltration system may comprise multiple ERDs configured in parallel, so that similar port types are joined together and function as one. In some embodiments, the same ERD may be associated with more than one semi-batch hyperfiltration system. Preferably, operation is of different semi-batch hyperfiltration systems are staged so that each PE is used in only one flush step at a time.

While certain of the preferred embodiments of the present invention have been described and specifically exemplified above, it is not intended that the invention be limited to such embodiments. Rather, it is to be understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A process for treating a raw water comprising:
providing a semi-batch hyperfiltration system 2 comprising:
a raw water source 4;
a feed line assembly 6 comprising a first feed path 10 extending from said raw water source 4 to a high-pressure pump 14, a second feed path 12, and a first junction 8 located within said first feed path 10 that connects said first feed path 10 to said second feed path 12;
a pressure vessel assembly 22 comprising a feed inlet 24, a concentrate outlet 26, a permeate outlet 28, and at least one pressure vessel 23 containing a plurality of hyperfiltration elements 54;
a recirculation loop 20 comprising a second junction 18 connected to said high-pressure pump 14, said recirculation loop 20 further comprising a feed flow path through the pressure vessel assembly 22 from the feed inlet 24 to the concentrate outlet 26, and a return path 32 external to the pressure vessel assembly 22 suitable to enable flow from the concentrate outlet 26 to the feed inlet 24; wherein a first section 32′ of the return path 32 joins the concentrate outlet 26 to a third junction 34 and a second section 32″ of the return path 32 joins a fourth junction 38 to the feed inlet 24; wherein the second section 32″ contains the second junction 18 and a recirculation pump 40; and
an energy recovery device (ERD) 42 comprising four ports:
a first ERD inlet port 44 fluidly connected to the second feed flow path 12,
a first ERD outlet port 46 suitable to provide a pressurized raw water to the recirculation loop 20 through the fourth junction 38,
a second ERD inlet port 48 suitable for receiving a pressurized concentrate stream from the recirculation loop 20 through the third junction 34,
a second ERD outlet port 50 fluidly connected to a brine effluent line 52 and suitable to provide a depressurized concentrate stream to said brine effluent line 52; and
repeatedly switching between first and second modes of operation, wherein
said first mode of operation is characterized by enabling flow between said first section 32′ of the return path 32 and said second section 32″ of the return path 32, and allowing concentrate fluid from the concentrate outlet 26 to mix at the second junction 18 with flow from the high-pressure pump 14, such that a combined stream is conveyed to the pressure vessel inlet 24; and liquid flows through the ERD 42 during at least a portion of said first mode; and
said second mode of operation is characterized by preventing flow between said first section 32′ of the return path 32 and said second section 32″ of the return path 32; passing a portion of fluid from the raw water source 4 sequentially into the second feed path 12, the first ERD inlet port 44, the first ERD outlet port 46, the fourth junction 38, and the second section 32″ of the return path 32; and
passing concentrate fluid from the concentrate outlet 26 sequentially into said first section 32′ of the return path 32, the third junction 34, the second ERD inlet port 48, the second ERD outlet port 50, the brine effluent line 52, and a brine discharge 68.

2. The process of claim 1, wherein flow between the second ERD outlet port 50 and the brine discharge 68 is prevented during at least the majority of time in the first mode that liquid flows through the energy recovery device 42.

3. The process of claim 1, wherein total flow of liquid through the ERD during the first mode exceeds by at least a factor of two the flow of liquid into the brine discharge 68 during the same time period.

4. The process of claim 1, wherein liquid flows predominantly through only two of the four ports of the ERD during the first mode.

5. The process of claim 1, wherein the first mode is divided into a first time interval and a second time interval, the second time interval being of lesser duration than the first time interval, and wherein a greater volume of liquid flows through the pressure exchange device during the second time interval.

6. The process of claim 5 wherein the second time interval is less than 50% of the first time interval.

7. The process of claim 1, wherein a control valve 37 is located in a section of the return path 32 connecting the third junction 34 and the fourth junction 38, and said control valve 37 is adjusted during the first mode to modify the rate at which liquid flows through the ERD.

8. The process of claim 1, wherein a valve (39 or 56″) prevents flow through the PE inlet port 44 during at least a portion of the first mode.

9. The process of claim 1, wherein flow through first ERD inlet port 44 and second ERD outlet port 50 is prevented during at least a part of the first mode.

10. The process of claim 1, wherein an effluent valve 57 is located in the brine effluent line 52, between the second ERD outlet port 50 and brine discharge 68.

11. The process of claim 1, wherein the semi-batch hyperfiltration system 2 further comprises a recovery path 64 suitable to enable flow from a fifth junction 62 located in the brine effluent line 52 to the raw water source 4 or to a sixth junction 66 located in the first feed path 10; wherein flow from the brine effluent line 52 is directed into the recovery path 64 during at least a portion of the first mode and into the discharge 68 during the second mode.

12. The process of claim 1, wherein the ERD comprises an isobaric energy exchanger.

13. The process of claim 1, wherein the ERD comprises a pressure exchanger (PE).

14. The process of claim 1, wherein the ERD comprises a positive displacement energy exchanger.

15. The process of claim 13 wherein the PE contains a rotor, and said rotor spins throughout the first mode.

16. The process of claim 13 wherein the PE contains a rotor, and said rotor spins at a faster rate in the second time interval.
